(19) United States
(12) Patent Application Publication
(10) Pub. No.: US 2020/0130943 A1
(43) Pub. Date: Apr. 30, 2020

(54) MATERIAL TRANSPORT SYSTEM

(71) Applicant: Thomas Gorder, Kalispell, MT (US)

(72) Inventor: Thomas Gorder, Kalispell, MT (US)

(21) Appl. No.: 16/172,397

(22) Filed: Oct. 26, 2018

(51) Int. Cl. B65G 17/20; B65G 19/02; B65G 17/12; B65G 35/00

(52) U.S. Cl. CPC B65G 17/20; B65G 19/025; B65G 17/12; B65G 47/1471; B65G 2201/02; B65G 2201/047; B65G 35/00

(57) ABSTRACT

A method for transporting material using a gravity driven pulley system is described. The method may include moving the material from a first location to a second location using a transport pulley secured to a cable and detaching the transport pulley from the cable at the second location, wherein the transport pulley is detached by a momentum of the transport pulley bringing the transport pulley into contact with a derailer attached to the cable.

### BACKGROUND

The following relates generally to transporting material, and more specifically to transporting material using a gravity driven pulley system.

There are many systems for transporting materials. Wood, firewood, and other materials are transported in a wooded area such as a forest, for example. Transporting materials between two locations can be repetitive. Carrying certain materials over a large distance can be heavy. Depending on the number and heaviness of the materials, transporting materials may require more than one person to perform the job, which may be inefficient.

### SUMMARY

A method for transporting material using a gravity driven pulley system is described. The method may include moving the material from a first location to a second location using a transport pulley secured to a cable and detaching the transport pulley from the cable at the second location, wherein the transport pulley is detached by a momentum of the transport pulley bringing the transport pulley into contact with a derailer attached to the cable.

Some examples of the method described above may further include securing the material to the transport pulley. Some examples of the method described above may further include placing a pulley wheel of the transport pulley onto the cable such that the pulley wheel may roll along the cable.

Some examples of the method described above may further include connecting the cable at a first end point and a second end point such that it extends from the first location to the second location. Some examples of the method described above may further include adjusting the tension of the cable using a tensioner.

In some examples of the method described above, the first location is at a higher altitude than the second location, and the material is transported by the force of gravity acting on the transport pulley and the material to pull the transport pulley along the cable.

Some examples of the method described above may further include pushing the transport pulley off of the cable using the derailer using a sloped surface of the derailer, wherein the pushing causes the transport pulley to be detached from the cable.

An apparatus for transporting material using a gravity driven pulley system is described. The apparatus may include a cable, a transport pulley comprising a pulley wheel and a frame, the frame extending in a vertical direction and the frame further comprising an attachment end that localizes to a lower position relative to the pulley wheel when the pulley wheel rests atop the cable, and wherein the attachment end is adapted to carry the material, and a derailer connected to the cable and configured to detach the transport pulley from the cable.

A method of producing an apparatus for transporting material is described. The method may include providing a cable, providing a transport pulley comprising a pulley wheel and a frame, the frame extending in a vertical direction and the frame further comprising an attachment end that localizes to a lower position relative to the pulley wheel when the pulley wheel rests atop the cable, and wherein the attachment end is adapted to carry the material, and providing a derailer connected to the cable and configured to detach the transport pulley from the cable.

Some examples of the apparatus and method described above may further include a tensioner comprising a first element, a second element, and a locking element. In some examples of the apparatus and method described above, the first element has an elongated body and comprises a pivotable position at an interior location, wherein a first end of the first element is connected to an anchoring device. In some examples of the apparatus and method described above, the second element has an elongated body, pivotably attached to the pivotable position, and moveably connected to the cable, wherein repeatedly pivoting the second element back and forth about the pivotable position moves the cable in relation to the second element and the first element and increases a tension in the cable. In this case, the tensioner includes a ratcheting mechanism. In some examples of the apparatus and method described above, the locking element is configured to lock the first element and the second element in a locking position.

In some examples of the apparatus and method described above, the tensioner further comprises a third element having an elongated body, wherein a first end of the the third element is pivotably attached to a second end of the first element.

In some examples of the apparatus and method described above, the derailer comprises a longitudinal opening, wherein a first surface of the derailer is connected to a first end of the derailer and has an upward grade towards a second end of the derailer and wherein the longitudinal opening is adapted for passage of the first cable. In some examples of the apparatus and method described above, the derailer comprises a lock configured to lock the derailer to a fixed point of the cable.

Some examples of the apparatus and method described above may further include an impact surface on the transport pulley that extends laterally from the frame and is adapted to strike the derailer.

### BRIEF DESCRIPTION OF THE DRAWINGS

FIG. 1 shows an example of a material transport system in accordance with aspects of the present disclosure.

FIG. 2 shows an example of a transport pulley in accordance with aspects of the present disclosure.

FIG. 3 shows an example of figure description in accordance with aspects of the present disclosure.

FIG. 4 shows an example of tensioner in accordance with aspects of the present disclosure.

FIGS. 5 through 7 show examples of a process for transporting material in accordance with aspects of the present disclosure.

### DETAILED DESCRIPTION

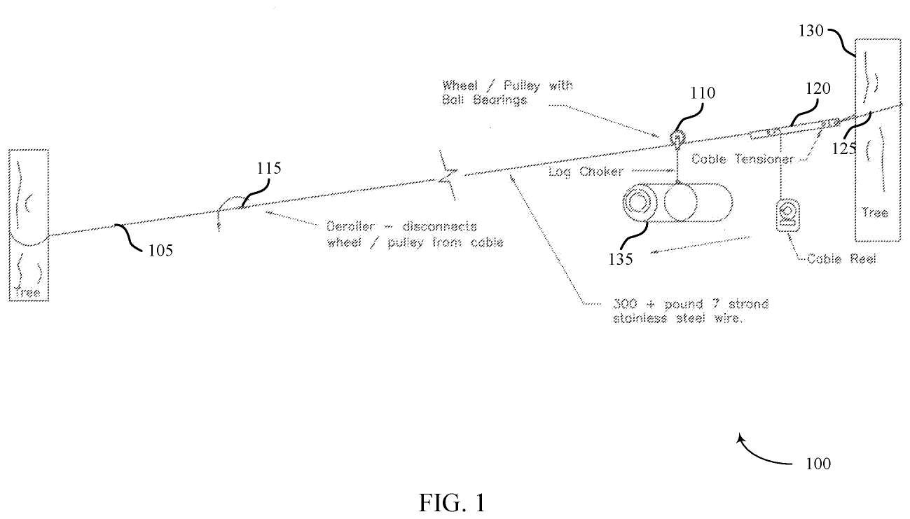

FIG. 1 shows an example of a material transport system 100 in accordance with aspects of the present disclosure. In certain embodiments, the material transport system 100 may include a cable 105, a transport pulley 110, a derailer 115, a tensioner 120, an anchoring device 125, a support structure 130, and a material 135.

The material transport system 100 may be used to transport material 135 from one location to another using the force of gravity. It may be configured such that the material 135 may be transported along a cable 105, and then detached from the cable 105 automatically. This may enable the system to be operated by a single user.

The cable 105 is connected between two structures. These structures can be trees. The cable 105 supports a derailer 115 and a transport pulley 110. Tension is introduced to the cable 105 with a tensioner 120 to support the material 135 being transported.

The tensioner 120 is used to introduce tension to the cable 105. In some cases, the tensioner 120 includes a turnbuckle type attachment. In some cases, the tensioner 120 includes a vice grip attachment. In some cases, the tensioner 120 includes a ratchet-type attachment. In some cases the tensioner 120 includes a plurality of elements that are folded and locked together to introduce tension.

The transport pulley 110 holds the material 135 to be transported. The material 135 or load is attached to the transport pulley 110. The transport pulley 110 has a pulley wheel, which rides along the cable 105. The transport pulley 110 has a frame, that is attached to the material 135 to be transported.

The derailer 115 is attached to the cable 105. The derailer 115 includes a lock that secures it to the cable 105. The transport pulley 110 impacts the derailer 115, which derails the transport pulley 110 from the cable 105. The derailer 115 is placed at a second location so that the transport pulley 110 holding the material 135 is deposited at the second location. The transport pulley 110 may be derailed, or the material 135 may be pushed off of the transport pulley 110.

In certain embodiments, the material transport system 100 includes moving the material 135 from a first location to a second location using a transport pulley 110 secured to a cable 105. In some examples, the first location is at a higher altitude than the second location, and the material 135 is transported by the force of gravity acting on the transport pulley 110 and the material 135 to pull the transport pulley 110 along the cable 105.

In certain embodiments, the material transport system 100 Transport pulley 110 may also move the material 135 from a first location to a second location using a transport pulley 110 secured to a cable 105. Transport pulley 110 may also secure the material 135 to the transport pulley 110. Transport pulley 110 may also place a pulley wheel of the transport pulley 110 onto the cable 105 such that the pulley wheel may roll along the cable 105.

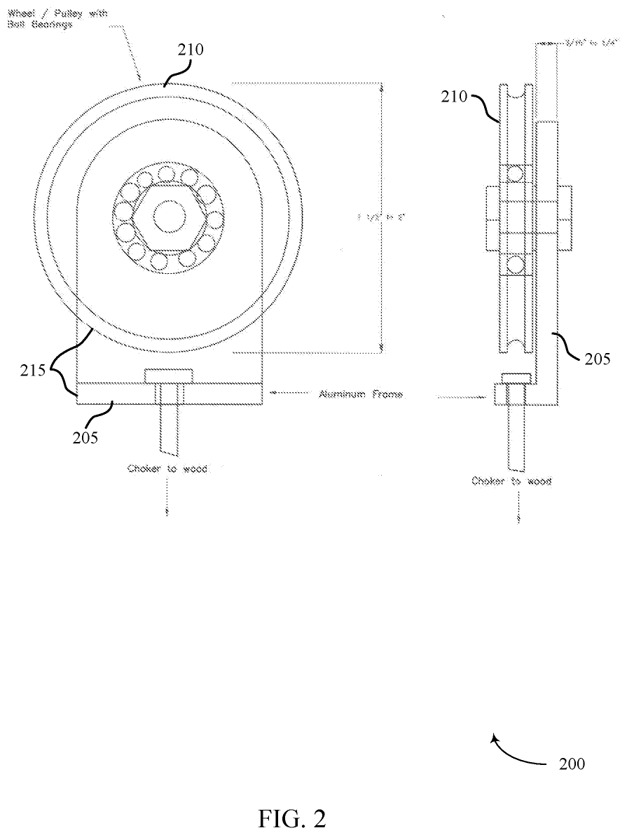

Transport pulley 110 may also comprise a pulley wheel and a frame, the frame extending in a vertical direction and the frame further comprising an attachment end that localizes to a lower position relative to the pulley wheel when the pulley wheel rests atop the cable 105, and wherein the attachment end is adapted to carry the material 135. Transport pulley 110 may be an example of, or include aspects of the corresponding elements described with reference to FIG. 2.

Derailer 115 may also function to detach the transport pulley 110 from the cable 105 at the second location, wherein the transport pulley 110 is detached by a momentum of the transport pulley 110 bringing the transport pulley 110 into contact with a derailer 115 attached to the cable 105. Derailer 115 may also push the transport pulley 110 off of the cable 105, where a sloped surface of the derailer 115 pushes and causes the transport pulley 110 to be detached from the cable 105.

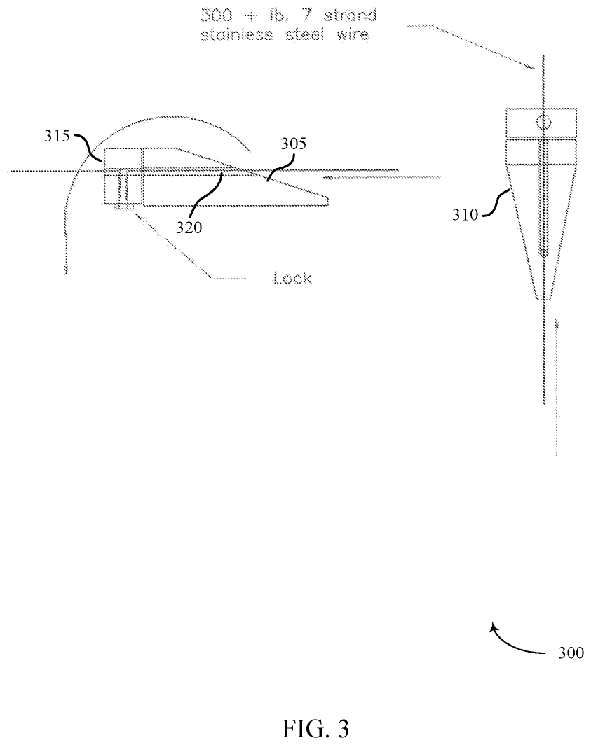

Derailer 115 may also be connected to the cable 105 and configured to detach the transport pulley 110 from the cable 105. In some examples, the derailer 115 comprises a longitudinal opening, wherein the longitudinal opening is adapted for passage of the first cable 105. In wherein a first surface of the derailer 115 is connected to a first end of the derailer 115 and has an upward grade towards a second end of the derailer 115 and In some examples, the derailer 115 comprises a lock configured to lock the derailer 115 to a fixed point of the cable 105. Derailer 115 may be an example of, or include aspects of, the corresponding elements described with reference to FIG. 3.

In certain embodiments, the tension of the cable 105 is adjusted using a tensioner 120. In certain embodiments, a tensioner 120 may comprise a first element, a second element and a locking element. In some examples, the first element has an elongated body and comprising a pivotable position at an interior location, wherein a first end of the first element is connected to an anchoring device 125. In some examples, the second element has an elongated body, pivotably attached to the pivotable position, and moveably connected to the cable 105, wherein repeatedly pivoting the second element back and forth about the pivotable position moves the cable 105 in relation to the second element and the first element and increases a tension in the cable 105. In this case, the tensioner includes a ratcheting mechanism.

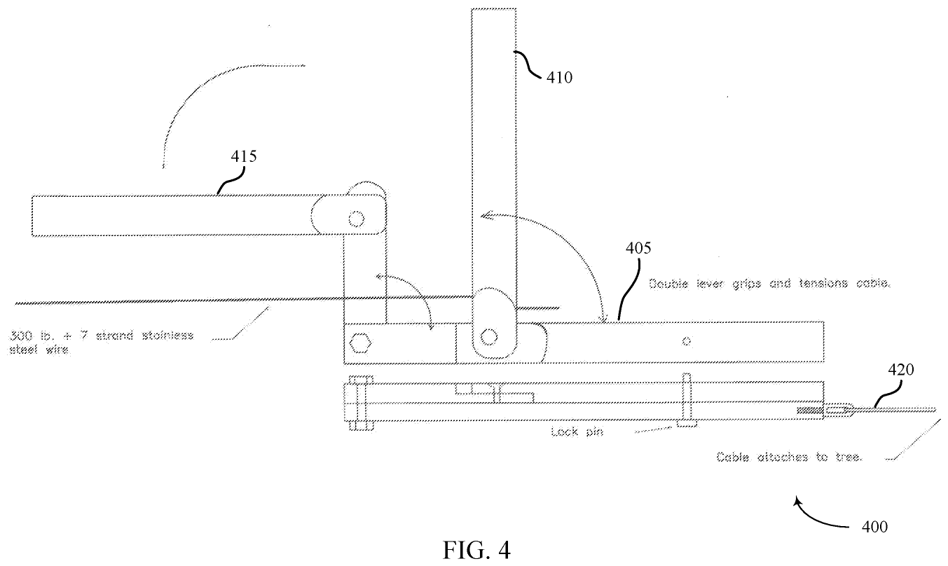

In some examples, the locking element is configured to lock the first element and the second element in a locking position. In some examples, the tensioner 120 further comprises a third element having an elongated body, wherein a first end of the third element is pivotably attached to a second end of the first element. Tensioner 120 may be an example of, or include aspects of, the corresponding elements described with reference to FIG. 4.

Anchoring device 125 may also connect the cable 105 at a first end point and a second end point such that it extends from the first location to the second location. For example, the anchoring device 125 may be an additional cable attached to a support structure 130, such as a tree. Anchoring device 125 may be an example of, or include aspects of, the corresponding elements described with reference to FIG. 4.

FIG. 2 shows an example of a transport pulley 200 in accordance with aspects of the present disclosure. The transport pulley 200 translocates across a cable. The transport pulley 200 has a frame 205, pulley wheel 210, and impact surface 215. The pulley wheel 210 attached to the frame 205. The pulley wheel 210 has a circumferential groove that allows it to ride along the cable. The frame 205 has a bottom portion that is weighted. The frame 205 is attached to the material to be transported. In some cases, the impact surface 215 may be located on the frame 205. In other cases, the impact surface 215 may be located on the wheel 210.

The impact surface 215 impacts the derailer, and causes the transport pulley 200 to be removed from the cable. Transport pulley 200 may be an example of, or include aspects of, the corresponding elements described with reference to FIG. 1.

FIG. 3 shows an example of figure description in accordance with aspects of the present disclosure. The derailer 300 generally has a wedge shape. The derailer 300 has a first surface 305 that has an upward grade. The upward grade connects the first end of the derailer 300 towards the second end. The second surface 310 has a grade that extends laterally. The second surface grade pushes the transport pulley laterally from the cable. The lock 315 secures the derailer 300 to the cable. The cable enters through the longitudinal opening or cable passage 320. Derailer 300 may be an example of, or include aspects of, the corresponding elements described with reference to FIG. 1.

FIG. 4 shows an example of tensioner 400 in accordance with aspects of the present disclosure. The tensioner 400 attaches to the cable. The tensioner 400 functions to create tension in the cable as to lift the cable above the ground, and transport a material across the ground. The tensioner 400 has a first element 405, and a second element 410. In another embodiment, a tensioner 400 includes a turnbuckle type attachment, a ratchet type attachment, and a vice-grip attachment (not shown). The first element 405 attaches to an anchoring device, and optionally a second element 410. The second element 410 pivots relative to the first element 405. The second element 410 also locks with the first element 405. The third element 415 is connected between the first element 405 and second element 410. Tensioner 400 may include a first element 405, a second element 410, a third element 415, and an anchoring device 420. An anchoring device 420 may be an example of, or include aspects of, the corresponding elements described with reference to FIG. 1.

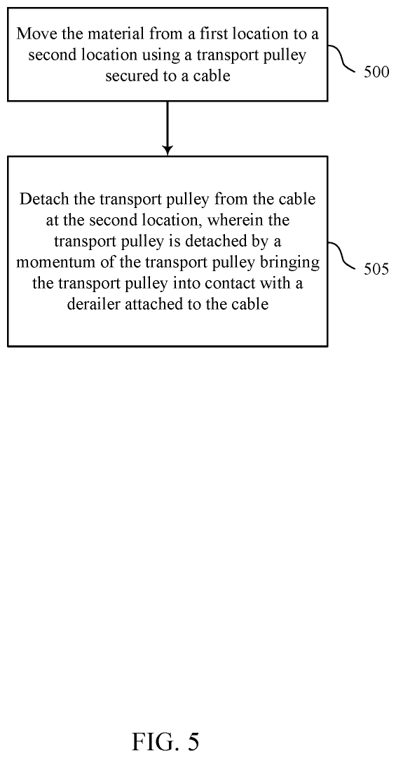

FIG. 5 shows an example of a process for transporting material in accordance with aspects of the present disclosure. Generally, these operations may be performed according to the methods and processes described in accordance with aspects of the present disclosure. For example, the operations may be composed of various substeps, or may be performed in conjunction with other operations described herein.

At step 500, the process may move the material from a first location to a second location using a transport pulley secured to a cable. In some cases, the operations of this step may refer to, or be performed by, a transport pulley as described with reference to FIGS. 1 and 2. In some cases, the operations of this step may refer to, or be performed by, a cable as described with reference to FIG. 1. In some cases, the operations of this step may refer to, or be performed by, a material transport system as described with reference to.

At step 505, the process may detach the transport pulley from the cable at the second location, wherein the transport pulley is detached by a momentum of the transport pulley bringing the transport pulley into contact with a derailer attached to the cable. In some cases, the operations of this step may refer to, or be performed by, a derailer as described with reference to FIGS. 1 and 3.

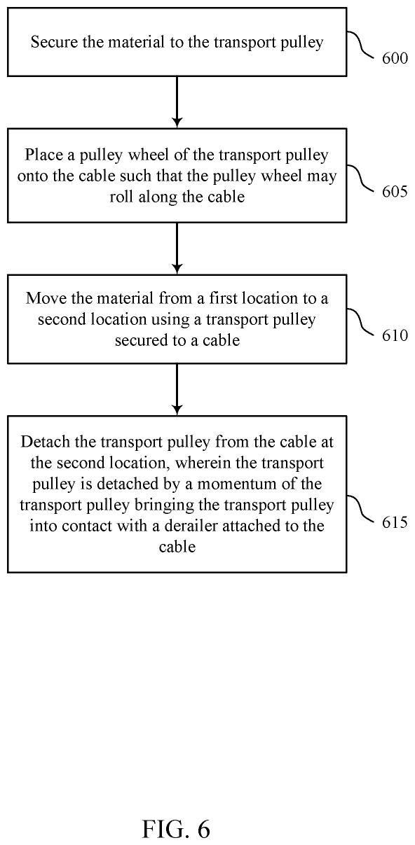

FIG. 6 shows an example of a process for transporting material in accordance with aspects of the present disclosure. Generally, these operations may be performed according to the methods and processes described in accordance with aspects of the present disclosure. For example, the operations may be composed of various substeps, or may be performed in conjunction with other operations described herein.

At step 600, the process may secure the material to the transport pulley. In some cases, the operations of this step may refer to, or be performed by, securing the material to the transport pulley as described with reference to FIGS. 1 and 2.

At step 605, the process may place a pulley wheel of the transport pulley onto the cable such that the pulley wheel may roll along the cable. In some cases, the operations of this step may refer to, or be performed with reference to the disclosure in FIGS. 1 and 2.

At step 610, the process may move the material from a first location to a second location using a transport pulley secured to a cable. In some cases, the operations of this step may refer to, or be performed by, a transport pulley as described with reference to FIGS. 1 and 2. In some cases, the operations of this step may refer to, or be performed by, a cable as described with reference to FIG. 1. In some cases, the operations of this step may refer to, or be performed by, a material transport system as described with reference to FIGS. 1 and 2.

At step 615, the process may detach the transport pulley from the cable at the second location, wherein the transport pulley is detached by a momentum of the transport pulley bringing the transport pulley into contact with a derailer attached to the cable. In some cases, the operations of this step may refer to, or be performed by, a derailer as described with reference to FIGS. 1 and 3.

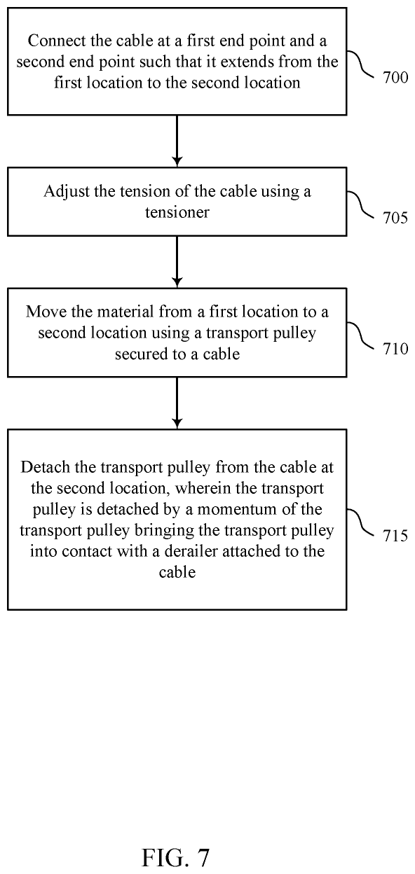

FIG. 7 shows an example of a process for transporting material in accordance with aspects of the present disclosure. Generally, these operations may be performed according to the methods and processes described in accordance with aspects of the present disclosure. For example, the operations may be composed of various substeps, or may be performed in conjunction with other operations described herein.

At step 700, the process may connect the cable at a first end point and a second end point such that it extends from the first location to the second location. In some cases, the operations of this step may refer to, or be performed by, an anchoring device as described with reference to FIGS. 1 and 4.

At step 705, the process may include adjusting the tension of the cable using a tensioner. In some cases, the operations of this step may refer to, or be performed by, a tensioner as described with reference to FIGS. 1 and 4.

At step 710, the process may include moving the material from a first location to a second location using a transport pulley secured to a cable. In some cases, the operations of this step may refer to, or be performed by, a transport pulley as described with reference to FIGS. 1 and 2. In some cases, the operations of this step may refer to, or be performed by, a cable as described with reference to FIG. 1.

At step 715, the process may include detaching the transport pulley from the cable at the second location, wherein the transport pulley is detached by a momentum of the transport pulley bringing the transport pulley into contact with a derailer attached to the cable. In some cases, the operations of this step may refer to, or be performed by, a derailer as described with reference to FIGS. 1 and 3.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.”

What is claimed is:

1. A method for transporting material, comprising:
moving the material from a first location to a second location using a transport pulley secured to a cable; and
detaching the transport pulley from the cable at the second location, wherein the transport pulley is detached by a momentum of the transport pulley bringing the transport pulley into contact with a derailer attached to the cable.

2. The method of claim 1, further comprising:
securing the material to the transport pulley; and
placing a pulley wheel of the transport pulley onto the cable such that the pulley wheel may roll along the cable.

3. The method of claim 1, further comprising:
connecting the cable at a first end point and a second end point such that it extends from the first location to the second location; and
adjusting the tension of the cable using a tensioner.

4. The method of claim 1, wherein:
the first location is at a higher altitude than the second location, and the material is transported by the force of gravity acting on the transport pulley and the material to pull the transport pulley along the cable.

5. The method of claim 1, further comprising:
pushing the transport pulley off of the cable using the derailer using a sloped surface of the derailer, wherein the pushing causes the transport pulley to be detached from the cable.

6. An apparatus for transporting material, comprising:
a cable;
a transport pulley comprising a pulley wheel and a frame, the frame extending in a vertical direction and the frame further comprising an attachment end that localizes to a lower position relative to the pulley wheel when the pulley wheel rests atop the cable, and wherein the attachment end is adapted to carry the material; and
a derailer connected to the cable and configured to detach the transport pulley from the cable.

7. The apparatus of claim 6, further comprising:
a tensioner comprising a first element, a second element and a locking element.

8. The apparatus of claim 7, wherein:
the first element has an elongated body and comprising a pivotable position at an interior location, wherein a first end of the first element is connected to an anchoring device;
the second element has an elongated body, pivotably attached to the pivotable position, and moveably connected to the cable, wherein repeatedly pivoting the second element back and forth about the pivotable position moves the cable in relation to the second element and the first element and increases a tension in the cable; and
the locking element is configured to lock the first element and the second element in a locking position.

9. The apparatus of claim 7, wherein:
the tensioner further comprises a third element having an elongated body, wherein a first end of the the third element is pivotably attached to a second end of the first element.

10. The apparatus of claim 6, wherein:
the derailer comprises a longitudinal opening, wherein a first surface of the derailer is connected to a first end of the derailer and has an upward grade towards a second end of the derailer and wherein the longitudinal opening is adapted for passage of the first cable.

11. The apparatus of claim 6, wherein:
the derailer comprises a lock configured to lock the derailer to a fixed point of the cable.

12. The apparatus of claim 6, further comprising:
an impact surface on the transport pulley that extends laterally from the frame and is adapted to strike the derailer.

13. A method of producing an apparatus for transporting material, the method comprising:
providing a cable;
providing a transport pulley comprising a pulley wheel and a frame, the frame extending in a vertical direction and the frame further comprising an attachment end that localizes to a lower position relative to the pulley wheel when the pulley wheel rests atop the cable, and wherein the attachment end is adapted to carry the material; and
providing a derailer connected to the cable and configured to detach the transport pulley from the cable.

14. The method of claim 13, the method further comprising:
providing a tensioner comprising a first element, a second element and a locking element.

15. The method of claim 14, wherein:
the first element has an elongated body and comprising a pivotable position at an interior location, wherein a first end of the first element is connected to an anchoring device;
the second element has an elongated body, pivotably attached to the pivotable position, and moveably connected to the cable, wherein repeatedly pivoting the second element back and forth about the pivotable position moves the cable in relation to the second element and the first element and increases a tension in the cable; and
the locking element is configured to lock the first element and the second element in a locking position.

16. The method of claim 14, wherein:
the tensioner further comprises a third element having an elongated body, wherein a first end of the the third element is pivotably attached to a second end of the first element.

17. The method of claim 13, wherein:
the derailer comprises a longitudinal opening, wherein a first surface of the derailer is connected to a first end of the derailer and has an upward grade towards a second end of the derailer and wherein the longitudinal opening is adapted for passage of the first cable.

18. The method of claim 13, wherein:
the derailer comprises a lock configured to lock the derailer to a fixed point of the cable.

19. The method of claim 13, the method further comprising:
providing an impact surface on the transport pulley that extends laterally from the frame and is adapted to strike the derailer.
